(19) United States
(12) Patent Application Publication
(10) Pub. No.: US 2015/0122784 A1
(43) Pub. Date: May 7, 2015

(54) LEVITATION APPARATUS AND LEVITATION METHOD

(71) Applicant: KOREA RESEARCH INSTITUTE OF STANDARDS AND SCIENCE, Daejeon (KR)

(72) Inventors: Geun-Woo LEE, Daejeon (KR); Sangho JEON, Daejeon (KR); Seung-Nam PARK, Daejeon (KR); Dong-Hee KANG, Daejeon (KR)

(21) Appl. No.: 14/523,435

(22) Filed: Oct. 24, 2014

Related U.S. Application Data
(63) Continuation of application No. PCT/KR2013/002839, filed on Apr. 5, 2013.

(30) Foreign Application Priority Data
Apr. 24, 2012 (KR) 10-2012-0042508

(51) Int. Cl. F27B 17/00

(52) U.S. Cl. CPC F27B 17/00
USPC 219/121.66; 219/121.65

(57) ABSTRACT

A levitation apparatus and a levitation method are provided. The levitation apparatus includes a top electrode and a bottom electrode disposed to be spaced apart from each other, a main power source adapted to apply a voltage to the top electrode or the bottom electrode such that a charged object levitates against gravity by using an electrostatic force generated by the voltage, a laser to heat the charged object, and spherical mirrors to re-reflect reflected light reflected from the charged object to the charged object. The reflected light may be generated when output light of the laser passing through a through-hole formed in a surface central region of each of the spherical mirrors is reflected by the charged object.

### CROSS-REFERENCE TO RELATED APPLICATIONS

This application is a continuation of and claims priority to PCT/KR2013/002839 filed on Apr. 5, 2013, which claims priority to Korea Patent Application No. 10-2012-0042508 filed on Apr. 24, 2012, the entireties of which are incorporated by reference herein.

### BACKGROUND

1. Technical Field

The present disclosure generally relates to levitation devices and, more particularly, to a melting technique using an electrostatic levitation apparatus.

2. Related Art

An electrostatic levitation apparatus includes a pair of electrodes. An electric field is applied to the pair of electrodes, and an electrostatic force generated by the electric field enables an object to levitate against gravity.

### SUMMARY

A subject matter of the present disclosure is to provide a levitation apparatus for effectively melting a spherical material of low emissivity in a levitating state by using low-output laser and a spherical mirror.

A levitation apparatus according to an embodiment of the present disclosure may include a top electrode and a bottom electrode disposed to be spaced apart from each other; a main power source adapted to apply a voltage to the top electrode or the bottom electrode such that a charged object levitates against gravity by using an electrostatic force generated by the voltage; a laser to heat the charged object; and spherical mirrors to re-reflect reflected light reflected from the charged object to the charged object. The reflected light may be generated when output light of the laser passing through a through-hole formed in a surface central region of each of the spherical mirrors is reflected by the charged object.

In an example embodiment, the levitation apparatus may further include a lens unit disposed between the laser and the spherical mirror to adjust the intensity of beam or a radius of a luminous flux of output light of the laser.

In an example embodiment, the levitation apparatus may further include a chamber disposed to cover the top electrode and the bottom electrode. The spherical mirror may be disposed inside the chamber.

In an example embodiment, the chamber may include at least one window made of zinc selenide (ZnSe) and the laser may be a carbon dioxide (CO₂) laser.

In an example embodiment, the chamber may include a vacuum chamber to exhaust the inside of the chamber.

In an example embodiment, the bottom electrode may be grounded and the top electrode may be applied with a negative high voltage by the main power source. The charged object may be charged with positive charges.

In an example embodiment, the levitation apparatus may further include a first east auxiliary electrode and a first west auxiliary electrode disposed to face each other with the top electrode or the bottom electrode therebetween; a second south auxiliary electrode and a second north auxiliary electrode disposed to face each other with the top electrode or the bottom electrode therebetween; a first auxiliary power source to apply a high voltage to the second south auxiliary electrode or the second north auxiliary electrode; and a second auxiliary power source to apply a high voltage to the first east auxiliary electrode or the first west auxiliary electrode.

In an example embodiment, the laser includes a first laser, a second laser, and a third laser. The first laser, the second laser, and the third laser may be arranged to be spaced apart from each other at regular interval of 120 degrees around the charged object.

In an example embodiment, the levitation apparatus may further include an auxiliary laser to measure a position of the charged object; and a position measurement sensor disposed to face the auxiliary laser with the charged object therebetween.

In an example embodiment, the levitation apparatus may further include a charging ultraviolet (UV) lamp to charge the charged object by the photoelectric effect.

In an example embodiment, the levitation apparatus may further include a radiation thermometer to measure a temperature of the charged object.

In an example embodiment, the levitation apparatus may further include an image ultraviolet (UV) lamp to irradiate UV light to the charged object; a focusing unit to focus output light of the image UV light on the charged object; and a camera disposed to face the image UV lamp with the charged object therebetween. The camera may include a UV pass filter.

A levitation method according to an embodiment of the present disclosure may include floating a charged object against gravity by using an electrostatic force; heating and melting the charged object through a laser; and letting output light of the laser re-reflect reflected light reflected from the charged object to the charged object by using a spherical mirror.

In an example embodiment, the levitation method may further include irradiating ultraviolet (UV) light such that the charged object are charged by the photoelectric effect; checking a position of the charged object; measuring a radiation temperature of the charged object; and irradiating UV light to the charged object to obtain a UV image.

A levitation apparatus according to an embodiment of the present disclosure may include an object levitation unit to levitate an object; a laser to heat the object; a spherical mirror to re-reflect reflected light reflected from the object to the object; an auxiliary laser to measure a position of the object; a position measurement sensor disposed to face the auxiliary laser with the object therebetween; an image ultraviolet (UV) lamp to irradiate UV light to the object; a focusing unit to focus output light of the image UV lamp on the object; and a camera disposed to face the image UV lamp with the object therebetween and including a UV pass filter. The reflected light may be generated when output light of the laser passing through a through-hole formed in a surface central region of each of the spherical mirrors is reflected by the charged object.

### BRIEF DESCRIPTION OF THE DRAWINGS

The present disclosure will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the present disclosure.

FIG. 1 illustrates characteristics of a luminous flux of laser.

FIG. 2 is a conceptual diagram of a levitation apparatus according to an embodiment of the present disclosure.

FIG. 3 illustrates characteristics of a Gaussian flux of laser from the levitation apparatus in FIG. 2.

FIG. 4 is a partial perspective view of a levitation apparatus according to an embodiment of the present disclosure.

FIG. 5 is a cross-sectional view taken along an X-Y plane of the levitation apparatus in FIG. 4.

FIG. 6 is a cross-sectional view taken along Z-axis of the levitation apparatus in FIG. 4.

### DETAILED DESCRIPTION

A blackbody is an ideal object that absorbs and emits all electromagnetic waves. An emissivity of the blackbody is 1. Therefore, apart from the blackbody, objects have an emissivity between 0 and 1. Electromagnetic waves that are not absorbed by the objects are reflected or transmitted. The emissivity is physical quantity that must be known to measure temperature of an object or calculate the energy absorption amount of a material in a non-contact fashion.

In recent years, properties of liquid samples have mainly been measured under a levitation environment. Especially, high-output laser has mainly been used to melt levitated solid samples. However, there are still many problems that must be overcome in terms of measurement, safety, and cost. Most metal samples have low emissivity (about 0.3 or less). Accordingly, some of output light of laser irradiated to a sample is absorbed and the rest of the output light is reflected. The reflected output light may have large energy and damage a structure inside a chamber. When the reflected output light leaks to the exterior of the chamber, the leakage of the reflected output light results in an accident. Moreover, when a sample having a melting point above absolute temperature of 2000 K (Kelvin) is melted, the high-output laser causes danger of accident and high cost.

A levitation apparatus according to an embodiment of the present disclosure may include a spherical mirror and low-output laser for melting a low-emissivity spherical material. The spherical mirror and the low-output laser may be combined with each other to improve melting efficiency of the low-output laser.

The present disclosure now will be described more fully hereinafter with reference to the accompanying drawings, in which preferred embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

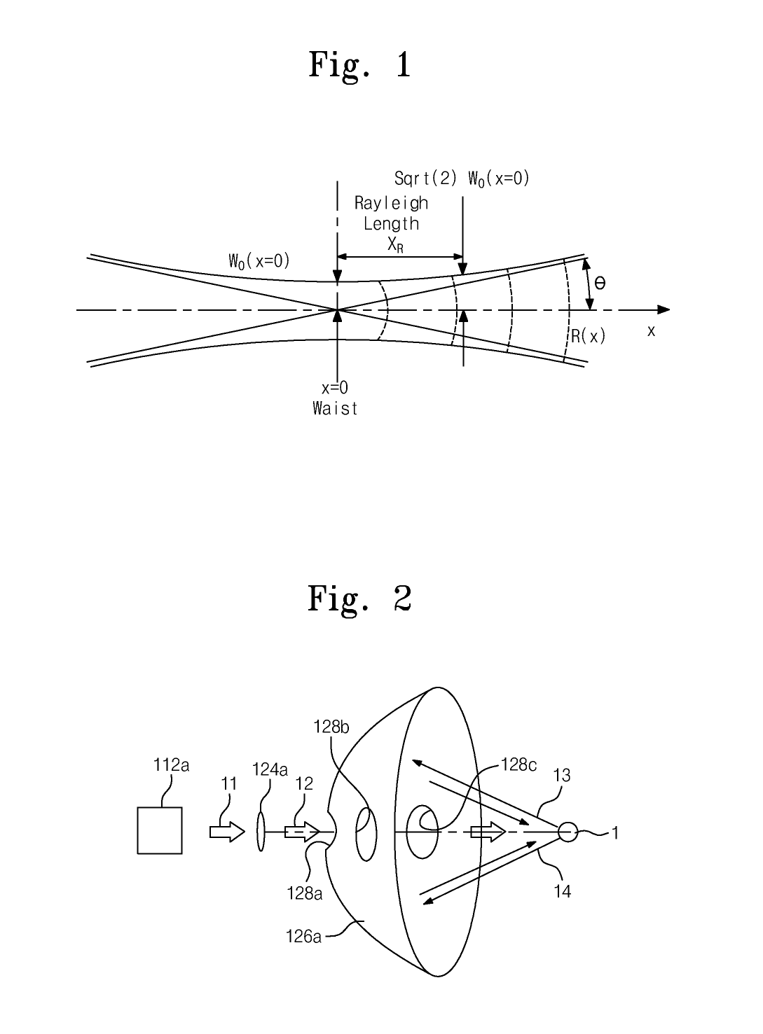

FIG. 1 illustrates characteristics of a luminous flux of laser.

Referring to FIG. 1, a luminous flux of laser may be a Gaussian flux. The Gaussian flux travels in the x-axis. At a focal point (x=0 point), a radius of the luminous flux is W₀. Rayleigh length is x_{R}, and a radius of the luminous flux in the Rayleigh length may be a point that is √2 W₀ of a minimum radius of luminous flux W₀. A diverging angle is θ. A Rayleigh area bₒ corresponds to an area regarded as a focal point.

Main beam parameters of the luminous flux are given by the equation below.

$$W ( x ) = {W}_{0} \sqrt{1 + {( \frac{x - {x}_{0}}{{b}_{0}} )}^{2}} \\ R = ( x - {x}_{0} ) [ 1 + {( \frac{{b}_{0}}{x - {x}_{0}} )}^{2} ] \\ {b}_{0} = \frac{n π {W}_{0}^{2}}{{λ}_{0}} \qquad Equation ( 1 )$$

In the Equation (1), W(x) represents a radius of a luminous flux (W₀ being a minimum radius of a luminous flux), R(x) represents a radius of curvature of a wave plane, and b₀ represents a Rayleigh area of a Gaussian flux. In addition, a diverging angle of the Gaussian flux is given as follows, 0=W₀/b₀. In addition, a wavelength of laser is λ₀ and n is a positive integer.

When the Gaussian flux passes a lens with a focal length of f, characteristics are given by the equation below.

$${b}_{0}^{′} = \frac{{f}^{2}}{{b}_{0}} \\ {W}_{0}^{′} = \frac{λ f}{π {W}_{0}} \qquad Equation ( 2 )$$

In the Equation (2), b₀ and W₀ represent a Rayleigh region and a minimum flux radius of an emitted flux, respectively.

FIG. 2 is a conceptual diagram of a levitation apparatus according to an embodiment of the present disclosure.

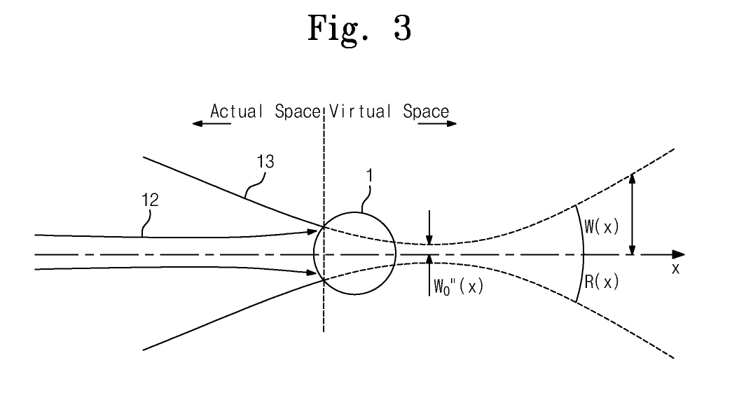

FIG. 3 illustrates characteristics of a Gaussian flux of laser from the levitation apparatus in FIG. 2.

Referring to FIGS. 2 and 3, output light 11 or a Gaussian flux emitted from laser 122a reaches an object 1 after being focused by a lens unit 124a. The object 1 may be spherical. When an emissivity of the object 1 is 0.3, energy of 70 percent of the Gaussian flux of the laser 122a is scattered or reflected again in a laser direction. After the scattered or reflected flux 13 is reflected by a spherical mirror 126a, the re-reflected flux 14 is irradiated to the object 1 to increase energy that the object 1 absorbs. Thus, an output of the output light of the laser 122a for melting the object 1 may decrease.

For example, when a diverging angle of high-output laser 122a is 2.5 milliradians (mrad), characteristics of the Gaussian flux are given by the equation below.

Gaussian flux before passing through lens θ(diverging angle of incident flux)=2.5 mrad w₀(minimum flux radius of incident flux)=λ/(2.5 mrad×7π)=1.35 mm b₀(Rayleigh region of incident flux)=πw₀²/λ=539 mm Equation (3)

When a wavelength λ of the laser 122a is 10.6 micrometers (μm) or less, a Gaussian flux 12 passing through the lens unit 124a having a focal length f of 254 millimeters (mm) is given by the equation below.

Gaussian flux after passing through lens(f=254 mm at 10.6 μm) b₀′(Rayleigh region of emitted flux)=f²/b₀=120 mm w₀′(minimum flux radius of emitted flux)=λf/πw₀=0.635 mm θ′(diverging angle of emitted flux)=w₀′/b₀′=5.29 mrad Equation (4)

The lens unit 124a irradiates a focused Gaussian flux to an object. Assuming that a melted object is a complete sphere having a radius of 1 mm, a focal length is 0.5 mm. Assuming that the melted object has a convex-mirror structure and is a spherical lens with a focal length f′ of a convex mirror, characteristics of a Gaussian flux reflected from the melted object are given by the equation below.

Gaussian flux reflected from object b₀″(Rayleigh region of emitted flux)=f²/b₀′=0.002 mm w₀″(minimum flux radius of emitted flux)=λf′/πw₀′=0.635 mm θ″(diverging angle of emitted flux)=w₀″/b₀″=1.3 mrad Equation (5)

For example, when a Gaussian flux 13 reflected in front of 200 mm spaced apart from the object 1 is calculated using the Equation (1), a radius of flux w″ is 266.5 mm and a radius of curvature of the spherical mirror is 200.5 mm. These values may vary depending on test environments. Accordingly, when a spherical mirror 126a corresponding to the flux radius and the radius of curvature is mounted, the Gaussian flux 13 re-irradiates the object 1 after being reflected by the spherical mirror 126a. Thus, an output of the laser 122a may be absorbed to the object 1 with maximum efficiency to maximize object melting efficiency and make the use of low-output laser possible. As a result, the cost may be reduced. Moreover, peripheral structures may be protected from reflected light or scattered light of the laser 122a. Thus, safety test environments may be created. The spherical mirror has a through-hole 128a on its central surface. The output light 12 of the laser 122a is irradiated to the object 1 via the through-hole 128a. The spherical mirror 126a may have auxiliary through-holes 128b and 128c for a signal path to other additional devices.

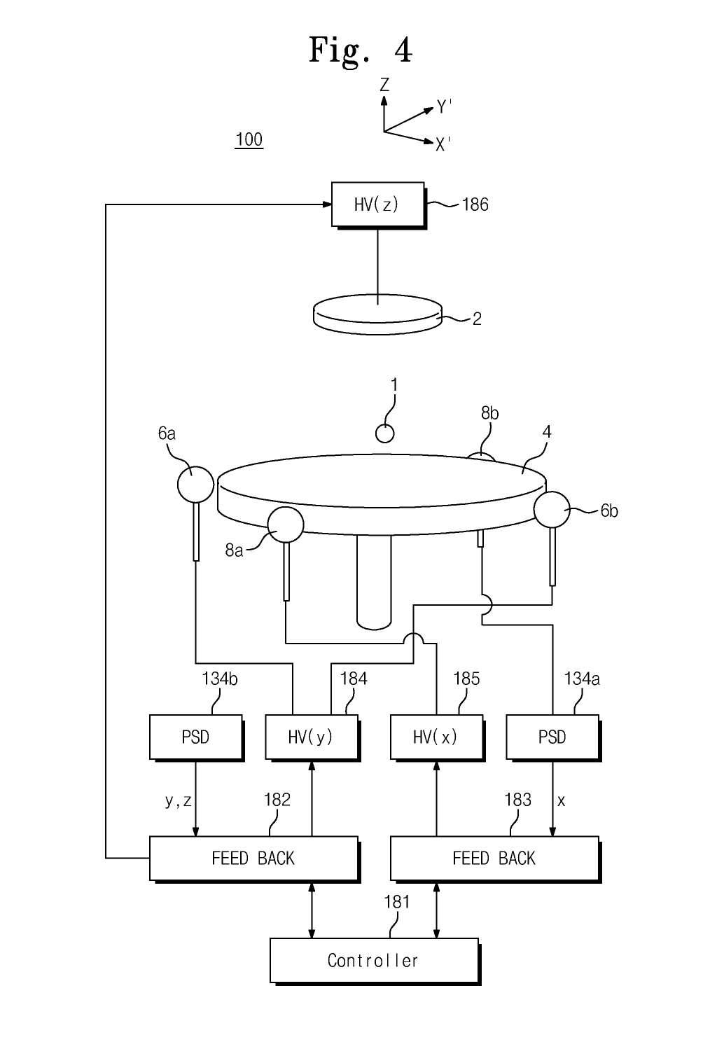

FIG. 4 is a partial perspective view of a levitation apparatus according to an embodiment of the present disclosure.

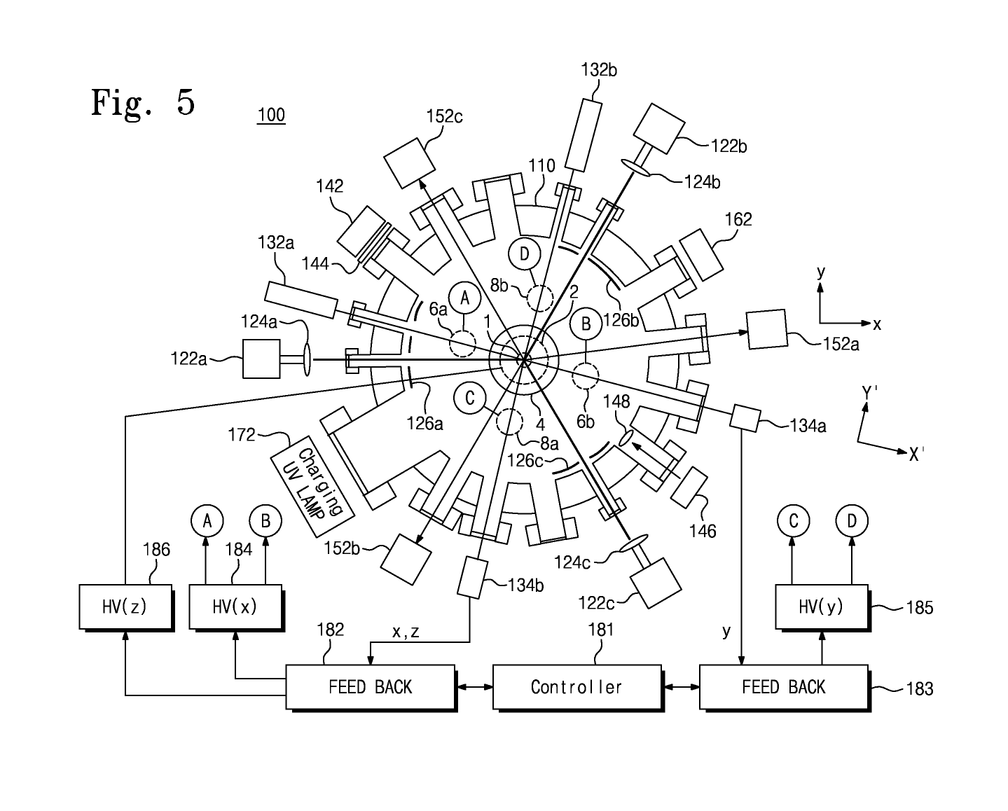

FIG. 5 is a cross-sectional view taken along an X-Y plane of the levitation apparatus in FIG. 4.

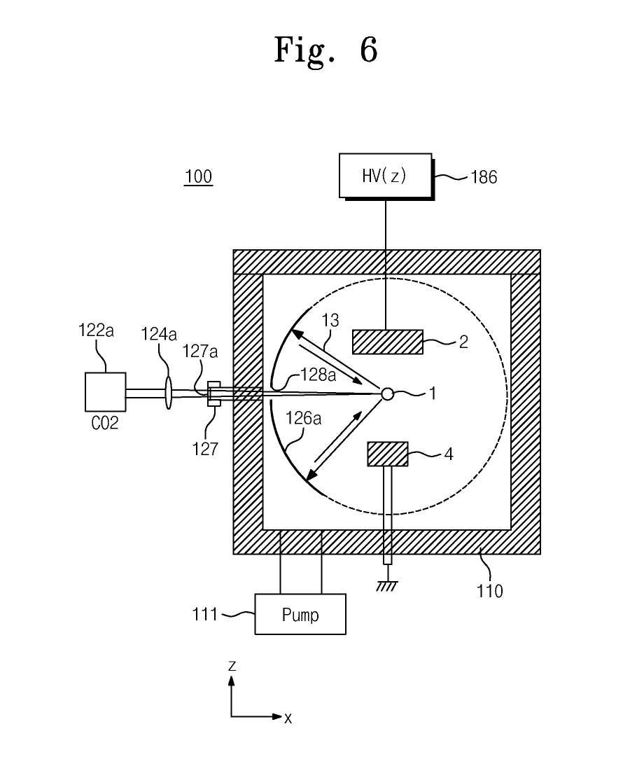

FIG. 6 is a cross-sectional view taken along Z-axis of the levitation apparatus in FIG. 4.

Referring to FIGS. 4 to 6, a levitation apparatus 100 may include a top electrode 2 and a bottom electrode 4 disposed to be spaced apart from each other, a main power source 186 adapted to apply a voltage to the top electrode 2 or the bottom electrode 4 such that a charged object 1 levitates against gravity by using an electrostatic force generated by the voltage, lasers 122a, 122b, and 122c to heat the charged object 1, and spherical mirrors 126a, 126b, and 126c to re-reflect reflected light 13 reflected from the charged object 1 to the charged object 1. The reflected light 13 is generated when output light of the laser passing through a through-hole 128a formed in a surface central region of each of the spherical mirrors 126a, 126b, and 126c is reflected by the charged object 1.

The top electrode 2 may be disc-shaped and made of a conductive material. A diameter of the top electrode 2 may be greater than that of the bottom electrode 4. The bottom electrode 4 may be grounded, and the top electrode 2 may be applied with a negative high voltage by the main power source 186. Thus, an electric field is established in a z-axis direction. The object 1 may be charged with positive charges. The object 1 may levitate by receiving an electrostatic force in a direction opposite to a gravity direction (−z axis direction). The intensity of the voltage applied to the top electrode 2 may depend on a distance between the top and bottom electrodes 2 and 4, mass of the object 1, and the charge amount of the object 1.

The top electrode 2 and the bottom electrode 4 may have the same central axis. An equipotential surface generated by the top electrode 2 and the bottom electrode 4 may be lowermost on the central axis. For achieving this, the top electrode 2 and the bottom electrode 4 may have a curved surface.

The main power source 186 may be a variable high-voltage DC voltage source. An output voltage of the main power source 186 may be variable.

The lasers 122a, 122b, and 122c may heat and melt the object 1. For achieving this, conventionally, outputs of the lasers 122a, 122b, and 12c may successively operate and may be between tens of watts and hundreds of watts. Each of the lasers 122a, 122b, and 122c may be carbon dioxide (CO₂) laser or YAG laser.

A chamber 110 may be disposed to cover the top electrode 2 and the bottom electrode 4. A vacuum pump 111 may be mounted to keep vacuum inside the chamber 110. The chamber 110 may be a cylindrical chamber of a metal material. A plurality of view ports may be formed on a side surface of the cylindrical chamber 110. The output light of the laser 122a may be provided to the object 1 via the view port 127. The view port 127 may include a window 127a.

The chamber 110 may include at least one window 127a which may be made of zinc selenide (ZnSe). In this case, output light of CO₂ laser may pass through the window 127a with less loss. A surface of the window 127a may be coated to increase a transmissivity at a predetermined wavelength. Conventionally, when output light of the CO₂ laser of hundreds of watts transmits the window 127a, the window 127a may be heated to be damaged. Therefore, it is necessary to reduce the outputs of the lasers 122a, 122b, and 122c for melting the object 1. For achieving this, the plurality of lasers 122a, 122b, and 122c may be used. Thus, the object 1 may be uniformly heated and the damage of each window 127a may be reduced.

Specifically, the laser may include a first laser 122a, a second laser 122b, and a third laser 122c. The first laser 122a, the second laser 122b, and the third laser 122c may be arranged to be spaced apart from each other at an interval of 120 degrees around the charged object 1. The lasers 122a, 122b, and 122c may be disposed outside the chamber 110. The first, second, and third lasers 122a, 122b, and 122c may be provided to the object 1 via their windows 127a, respectively.

The output light of the lasers 122a, 122b, and 122c may be a Gaussian flux, and a radius of the Gaussian flux may be a few centimeters. A radius of the object 1 may be a few millimeters. Accordingly, lens units 124a, 124b, and 124c may be disposed between the lasers 122a, 122b, and 122c and the object 1 to reduce the radius of the flux, respectively. Preferably, the lens units 124a, 124b, and 124c may be disposed between the lasers 122a, 122b, and 122c and the window 127a, respectively. Each of the lens units 124a, 124b, and 124c may be a single convex lens or may include a pair of lens having a confocal point. Alternatively, the lens units 124a, 124b, and 124c may be disposed between the lasers 122a, 122b, and 122c and spherical mirrors 126a, 126b, and 126c to adjust the beam size or the radius of flux of the output light of the laser, respectively.

Each of the spherical mirrors 126a, 126b, and 126c may be in the form of a sphere having a constant radius of curvature. The spherical mirrors 126a, 126b, and 126c may be disposed inside the chamber 110. A through-hole 128a may be formed in a central surface region of the spherical mirror 126a. A radius of the through-hole 128a may be greater than that of flux of the output light passing through a focusing unit. The spherical mirror 126a may move in an x-axis direction, a y-axis direction, and a z-axis direction. A focal point of the spherical mirror and a focal point of the object 1 may match each other. The radius of curvature of the spherical mirrors 126a, 126b, and 126c may vary depending on their positions. Specifically, the more the spherical mirrors 126a, 126b, and 126c are close to the object 1, the more a radius of curvature and a size of each of the spherical mirrors 126a, 126b, and 126c may be reduced.

The spherical mirrors 126a, 126b, and 126c may have other auxiliary through-holes apart from the through-hole 128a formed in the central surface. The auxiliary through-holes may be formed to operate other additional devices.

Auxiliary electrodes 6a, 6b, 8a, and 8b may be disposed around the top electrode 2 or the bottom electrode 4. Specifically, a first east auxiliary electrode 6b and a first west auxiliary electrode 6a may be disposed to face each other with the bottom electrode 4 therebetween. The first east auxiliary electrode 6b and the first west auxiliary electrode 6a may be spherical.

A second south auxiliary electrode 8a and a second north auxiliary electrode 8b may be disposed around the top electrode 2 or the bottom electrode 4. The second south auxiliary electrode 8a and the second north auxiliary electrode 8b may be spherical.

The second south auxiliary electrode 8a and the second north auxiliary electrode 8b may be disposed to face each other along a y′-axis with the bottom electrode 4 therebetween. A first auxiliary power source 185 may apply a high voltage to the second south auxiliary electrode 8a or the second north auxiliary electrode 8b to apply an electric field in the y′-axis direction. For example, one of the second south and north auxiliary electrodes 8a and 8b may be grounded and the other may be connected to the first auxiliary power source 185 to receive a voltage and apply an electric field in the y′-axis direction. Accordingly, when a position of the object 1 is out of the central axis or a set position of the bottom electrode 4, the first auxiliary power source 185 may operate to restore the object 1 to an original position.

Auxiliary lasers 132a and 132b may be disposed outside the chamber 110 to measure a position of the charged object 1. Outputs of the auxiliary lasers 132a and 132b may be irradiated to the object 1 via a window. Each of the auxiliary lasers 132a and 132b may be a helium-neon (He—Ne) laser.

Position measurement sensors 134a and 134b may be disposed to face the auxiliary lasers 132a and 132b with the charged object 1 therebetween, respectively. The position measurement sensors 134a and 134b may measure a position of the object 1 through a shadow image formed by reflected light scattered by the object 1.

The auxiliary lasers 132a and 132b may be disposed in an axis direction of an x′-y′ plane that is formed by rotating an x-y plane around a z-axis at a predetermined angle. Specifically, the first auxiliary laser 132a and the first position measurement sensor 134a may be mounted in an x′-axis direction. In addition, the second auxiliary laser 132b and the second position measurement sensor 134b may be mounted in a y′-axis direction.

A measurement result of the first position measurement sensor 134a may provide a position on a y′-z′ coordinate. The measurement result of the first position measurement sensor 134a may be provided to a first feedback unit 183. The first feedback unit 183 may check a position of an object of a y′-axis direction to provide a first position control signal to the first auxiliary power source 185. Thus, the first auxiliary power source 185 may receive the first position control signal to apply a predetermined voltage to the second south auxiliary electrode 8a or the second north auxiliary electrode 8b. The position of the object may be controlled.

A measurement result of the second position measurement sensor 134 may provide a position on an x′-z coordinate. The measurement result of the second position measurement sensor 134 may be provided to a second feedback unit 182. The second feedback unit 182 may check a position of an object of an x′-axis direction and a z-axis direction to provide a second position control signal to the second auxiliary power source 184. Thus, the second auxiliary power source 184 may receive the second position control signal to apply a predetermined voltage to the first east auxiliary electrode 6b or the first west auxiliary electrode 6a. The position of the object may be controlled. In addition, the second feedback unit 182 may provide a third position control signal to the main power source 186.

The second auxiliary power source 184 may receive the second position control signal and output a predetermined voltage to control the position of the object. The main power source 186 may receive the third position control signal and output a predetermined voltage to the top electrode 2 to control a z-axis position of the object.

A charging UV lamp 172 may charge the charged object 1 by the photoelectric effect. A main wavelength of the charging UV lamp 172 may be 160 nm. The charging UV lamp 172 may compensate a decrease in the charge amount due to mass decrease caused by evaporation of the object 1. Thus, the charging UV lamp 172 may continuously operate during the evaporation of the object 1 to maintain the constant charge amount.

An ultraviolet (UV) image may be used to measure the density of the object 1. When the object 1 is heated at high temperature, the melted object 1 may perform blackbody radiation with heating caused by the high temperature. Therefore, the blackbody radiation makes it difficult to discriminate a boundary of the object 1 on a conventional camera image of the object 1. However, UV passing through the object 1 may make the boundary of the object 1 clear. Thus, since a size of the object 1 is clearly measured, the density of the object 1 may be accurately measured.

An image UV lamp 146 may irradiate UV to the charged object 1 to obtain a UV image. The image UV lamp 146 is disposed outside the chamber 110, and output light of the image UV lamp 146 is irradiated to the object 1 through a window. A focusing unit 148 focuses the output of the image UV lamp 146 on the charged object 1. The focusing unit 148 may be a convex lens. A UV camera 142 may be disposed to face the image UV lamp 146 with the charged object 1 therebetween. The UV camera 142 includes a UV pass filter 144. Therefore, the UV pass filter 144 may be designed to allow only the output light of the image UV lamp 146 to pass through the UV pass filter 144. Thus, since a portion reflected or scattered by the object 1 is in black, a radius of the object 1 can be obtained. Preferably, the image UV lamp 146 is disposed perpendicular to the charging UV lamp 172 to prevent the output of the charging UV lamp 172 from impinging on the UV camera 142.

Radiation thermometers 152a, 152b, and 152c may measure radiation temperature of the charged object 1. The radiation thermometers 152a, 152b, and 152c may be disposed opposite to the lasers 122a, 122b, and 122c, respectively.

A black-and-white camera 162 may be disposed opposite to the charging UV lamp 172.

A controller 181 may receive data from the radiation thermometers 152a, 152b, and 152c and the UV camera 142. Moreover, the controller 181 may receive data from the first feedback unit 183 and the second feedback unit 182. The controller 181 may analyze and process data and display the result on a screen.

As described so far, a levitation apparatus according to an embodiment of the present disclosure re-reflects and focuses reflected light of a laser reflected from an object to the object to melt the object. Thus, melting efficiency of an output of the laser may be maximized and the cost of the laser may be reduced. Furthermore, the levitation apparatus may protect structures disposed inside a chamber from scattered light or reflected light of the laser and provide safety test environments.

Although the present disclosure has been described in connection with the embodiment of the present disclosure illustrated in the accompanying drawings, it is not limited thereto. It will be apparent to those skilled in the art that various substitutions, modifications and changes may be made without departing from the scope and spirit of the present disclosure.

What is claimed is:

1. A levitation apparatus comprising:
a top electrode and a bottom electrode disposed to be spaced apart from each other;
a main power source adapted to apply a voltage to the top electrode or the bottom electrode such that a charged object levitates against gravity by using an electrostatic force generated by the voltage;
a laser to heat the charged object; and
spherical mirrors to re-reflect reflected light reflected from the charged object to the charged object,
wherein the reflected light is generated when output light of the laser passing through a through-hole formed in a surface central region of each of the spherical mirrors is reflected by the charged object.

2. The levitation apparatus of claim 1, further comprising:
a lens unit disposed between the laser and the spherical mirror to adjust the beam size or a radius of a luminous flux of output light of the laser.

3. The levitation apparatus of claim 1, further comprising:
a chamber disposed to cover the top electrode and the bottom electrode, wherein the spherical mirror is disposed inside the chamber.

4. The levitation apparatus of claim 3, wherein the chamber includes at least one window made of zinc selenide (ZnSe), and
wherein the laser is a carbon dioxide (CO₂) laser.

5. The levitation apparatus of claim 3, wherein the chamber includes a vacuum chamber to exhaust the inside of the chamber.

6. The levitation apparatus of claim 1, wherein the bottom electrode is grounded,
wherein the top electrode is applied with a negative high voltage by the main power source, and
wherein the charged object is charged with positive charges.

7. The levitation apparatus of claim 1, further comprising:
a first east auxiliary electrode and a first west auxiliary electrode disposed to face each other with the top electrode or the bottom electrode therebetween;
a second south auxiliary electrode and a second north auxiliary electrode disposed to face each other with the top electrode or the bottom electrode therebetween;
a first auxiliary power source to apply a high voltage to the second south auxiliary electrode or the second north auxiliary electrode; and
a second auxiliary power source to apply a high voltage to the first east auxiliary electrode or the first west auxiliary electrode.

8. The levitation apparatus of claim 1, wherein the laser includes a first laser, a second laser, and a third laser, and
wherein the first laser, the second laser, and the third laser are arranged to be spaced apart from each other at regular interval of 120 degrees around the charged object.

9. The levitation apparatus of claim 1, further comprising:
an auxiliary laser to measure a position of the charged object; and
a position measurement sensor disposed to face the auxiliary laser with the charged object therebetween.

10. The levitation apparatus of claim 1, further comprising:
a charging ultraviolet (UV) lamp to charge the charged object by the photoelectric effect.

11. The levitation apparatus of claim 1, further comprising:
a radiation thermometer to measure a temperature of the charged object.

12. The levitation apparatus of claim 1, further comprising:
an image ultraviolet (UV) lamp to irradiate UV light to the charged object;
a focusing unit to focus output light of the image UV light on the charged object; and
a camera disposed to face the image UV lamp with the charged object therebetween,
wherein the camera includes a UV pass filter.

13. A levitation method comprising:
levitating a charged object against gravity by using an electrostatic force;
heating and melting the charged object through a laser; and
letting output light of the laser re-reflect reflected light reflected from the charged object to the charged object by using a spherical mirror.

14. The levitation method of claim 13, further comprising:
irradiating ultraviolet (UV) light such that the charged object are charged by the photoelectric effect;
checking a position of the charged object;
measuring a radiation temperature of the charged object; and
irradiating UV light to the charged object to obtain a UV image.

15. A levitation apparatus comprising:
an object levitation unit to levitate an object;
a laser to heat the object;
a spherical mirror to re-reflect reflected light reflected from the object to the object;
an auxiliary laser to measure a position of the object;
a position measurement sensor disposed to face the auxiliary laser with the object therebetween;
an image ultraviolet (UV) lamp to irradiate UV light to the object;
a focusing unit to focus output light of the image UV lamp on the object; and
a camera disposed to face the image UV lamp with the object therebetween and including a UV pass filter,
wherein the reflected light is generated when output light of the laser passing through a through-hole formed in a surface central region of each of the spherical mirrors is reflected by the charged object.
